(19) United States
(12) Patent Application Publication
(10) Pub. No.: US 2008/0296036 A1
(43) Pub. Date: Dec. 4, 2008

(54) Shiftable Clutch for an Electric Power Tool

(76) Inventors: Robert Simm, Oekingen (CH); Cornelis Van Der Schans, Dietlikon (CH)

Correspondence Address: MICHAEL J. STRIKER, 103 EAST NECK ROAD, HUNTINGTON, NY, 11743, US

(21) Appl. No.: 12/094,636

(22) PCT Filed: Jan. 15, 2007
(86) PCT No.: PCT/EP07/50339

§ 371 Date: May 22, 2008

(30) Foreign Application Priority Data
Mar. 3, 2006 (DE) 10 2006 009 922.2

(51) Int. Cl. B23B 45/00; F16D 67/02

(52) U.S. Cl. 173/178; 192/223

(57) ABSTRACT

The invention relates to a clutch (2) for a hand-operated electrical tool, in particular for a hand-held electrical device with a rotating tool, such as a drill or hammer drill, where the clutch (2) disengages automatically when a defined disengagement torque is exceeded. The invention further relates to a hand-operated electrical tool, in particular a hand-held electrical device with a rotating tool, which has this type of clutch (2). The clutch (2) is switchable between two clutch conditions, which have a different level of disengagement torque.

The invention relates to a clutch for a hand-actuated electric power tool, in particular for a handheld electric tool, such as a power drill or power percussion drill, having a rotating tool, as generically defined by the preamble to claim 1, and to a hand-actuated electric power tool as defined by the preamble to claim 10.

### PRIOR ART

High-quality power percussion drills as a rule have a 2-speed gear and an overload clutch, which if the rotating drilling tool blocks disengages automatically, in order to limit the maximum torque transmitted to the housing of the power percussion drill and thus to the user. Thus in the event of a sudden stoppage of the drilling tool, rotation of the housing of the power percussion drill about the axis of rotation of the drilling tool, which can cause injury to the user, or an overload on the drive motor, which can cause damage to the power percussion drill, is prevented from occurring. The overload clutch is typically located in a drive train between a drive motor or gear and a drill spindle, serving to receive a drilling tool, of the power percussion drill and usually includes two clutch elements whose adjacent clutch faces are provided with brake linings, undulating contours, or ratchet surfaces and are pressed elastically against one another, so that they can rotate relative to one another about their axis of rotation if, upon blockage of the drill spindle, the torque transmitted by the drive motor to the adjacent clutch element exceeds the disengagement torque, or in other words the maximum torque that can be transmitted between the clutch faces up to the point of slippage. The overload clutch furthermore also limits the maximum available torque at the drilling tool, as a function of the gear speed selected.

### ADVANTAGES OF THE INVENTION

The invention therefore proposes providing hand-actuated electric power tools and in particular handheld electric tools that have a rotating tool, such as a power drill or power percussion drill, with a clutch which automatically opens or disengages if a defined opening or disengagement torque is exceeded and is characterized in that the clutch can be switched between two clutch states, in which the opening or disengagement torque is variously high.

The term “disengages” or “opens” should not necessarily be understood, in the context of the present application, as an axial relative motion of two clutch elements, since the term “clutch” also includes friction clutches, in which upon disengagement or opening no relative motion of the clutch elements takes place.

Because of the possibility of changing the clutch setting or the magnitude of the disengagement torque, the user can better adjust the electric power tool to his needs. For instance, in a 2-speed power percussion drill with a clutch that can be switched back and forth between two clutch states, it is possible by the combination of the adjustment possibilities of selecting gear speeds and of the clutch overall to select clutch states with variously high disengagement torques. Alternatively, the number of torques that can be set at the drilling tool, in a preferred feature of the invention, can also, however, be increased by providing that the clutch can be switched over to a further clutch state, in which it is blocked, so that at the drilling tool, the maximum blocking torque of the selected gear speed is available.

The choice of the setting of the clutch state and the gear speed can be made in terms of safety, for instance a maximum-safety setting for an inexperienced user, or a normal-safety setting for a more-experienced user, and/or in terms of the desired or required torque at the rotating tool; for instance, as needed, a torque at the level of the maximum blocking torque at the drilling tool can be furnished by blocking or switching off the clutch in a targeted way by selecting the further clutch state.

One advantageous feature of the invention provides that the clutch is embodied as a slip clutch and includes two pairs of cooperating clutch faces, which at variously high disengagement torques rotate automatically counter to one another with slippage of the clutch and in each of the two clutch states one of each of the two pairs of clutch faces is blocked against rotation, so that only the clutch faces of the other pair are capable of rotating counter to one another.

A further preferred embodiment of the invention provides that the clutch faces of each of the two pairs of clutch faces have different engagement contours and/or surface properties, so as to attain the different disengagement torques, yet are pressed against one another with essentially the same force, so that the mutual elastic pressure of the diametrically opposed clutch faces of both pairs can be accomplished with the aid of a single contact pressure device, preferably a cup spring assembly. For instance, the diametrically opposed clutch faces of one of the two pairs can have undulating contours, which when the clutch is engaged mesh with one another in such a way that the gently rounded, shallow crests of one clutch face rest on the complementary troughs of the other clutch face, while the clutch faces of the other pair can have ratchet profiles with complementary protrusions and indentations that have lower and steeper flanks and therefore do not rotate counter to one another until a higher disengagement torque occurs. For lesser disengagement torques, the two diametrically opposed clutch faces may also be provided with smooth brake linings with a high coefficient of adhesion.

Alternatively, it would also be conceivable, however, for the clutch faces of both pairs to have identical engagement contours but to be pressed against one another with different forces.

In still another preferred embodiment of the invention, the two pairs of clutch faces each comprise two diametrically opposed axial end faces of three clutch elements integrated into the drive train of the electric power tool that are preferably located in line with one another along a common axis of rotation, so that the clutch faces located on the insides, facing one another, of the two outer clutch elements and on the outsides, facing away from one another, of the middle clutch element can be pressed elastically against one another in the direction of the axis of rotation by spring force. This kind of arrangement of the three clutch elements, preferably on a shaft that is rotatable about the axis of rotation, makes it possible to select the two clutch states with the variously high disengagement torques by means of a switching element that is movable in the axial direction of the shaft, by providing that one pair of clutch elements is connected by means of the switching element to one another in a manner fixed against relative rotation, so that only the clutch faces of the other pair can rotate counter to one another when the applicable disengagement torque is reached.

To establish the further clutch state in which the clutch is blocked, the switching element can preferably have a greater axial length than the middle clutch element and can thus be slipped onto the middle clutch element in such a way that it spans it and extends past both pairs of clutch faces, so that all three clutch elements are coupled to one another in a manner fixed against relative rotation.

The switching element may expediently be embodied as a switching ring that can be displaced along the outer circumferential faces of the clutch elements; axial keys embodied on the inner circumferential face of the switching ring mesh in form-locking fashion with complementary axial splines in the circumferential faces of the respective clutch elements. For adjusting the two clutch states with the variously high disengagement torques, two different pairs each of adjacent clutch elements are joined together in form-locking fashion by means of the switching ring, while for selecting the further clutch state, in which the clutch is blocked or “shut off”, all three clutch elements are connected to one another in form-locking fashion.

Alternatively, the switching element may include a single, larger driving key, which is displaceable for the same purpose in a complementary spline of the clutch elements.

Fundamentally, the possibility also exists of providing the two pairs of clutch faces on different shafts of the electric tool, for instance in a power percussion drill with switching elements integrating one pair of clutch faces having the lesser disengagement torque with the drill spindle and installing the other pair of clutch faces having the greater disengagement torque on a layshaft of the gear. Each pair of clutch faces can be blocked by means of a switching element, and as a result, it is possible on the one hand to establish two different clutch states with different disengagement torques, at the clutch faces that are not blocked, and on the other hand to establish a still another clutch state, in which the clutch is shut off, by blocking both pairs of clutch faces.

### DRAWINGS

The invention will be described in further detail below in terms of two exemplary embodiments in conjunction with the drawings. Shown are:

FIGS. 1 through 3, side views of a clutch according to the invention in various clutch states;

FIGS. 4 through 6, perspective views of the clutch in the various clutch states;

FIG. 7, a perspective view of a somewhat modified clutch.

### DESCRIPTION OF THE EXEMPLARY EMBODIMENTS

The shiftable slip or slide clutch 2 shown in the drawings for a power percussion drill (not shown) with a 2-speed shift transmission is located on a shaft 4 that forms a part of a drive train between an electric drive motor (not shown) and a drill spindle (not shown) of the power percussion drill.

The shaft 4 oriented parallel to the axis of rotation of the drive motor or drill spindle is supported rotatably, by its two opposite face ends 6, 8 in roller bearings of a housing of the power percussion drill. In the vicinity of one face end 6, the shaft 4 has two driving gear wheels 10, 12, located in line with one another along the shaft 4, with straight toothing and different diameters and a different number of teeth, both of them connected to the shaft 4 in a manner fixed against relative rotation by being pressed onto the shaft 4. Of the two driving gear wheels 10, 12, the larger one, 12, meshes in first gear, that is, at a lower rpm of the drill spindle, and the smaller meshes in second gear, that is, at higher rpm of the drill spindle, with a gear wheel (not shown) of the drive train that is driven by the drive motor and has a complementary toothing and rotates about an axis of rotation that is parallel to the axis of rotation 13 of the shaft 4. In the vicinity of its other face end 8, the shaft 4 has a driven gear wheel 14 with helical toothing, which meshes with a further helical-toothed gear wheel, driving the drill spindle, in the drive train of the power drill. The driven gear wheel 14 is supported freely rotatably on the shaft 4 and is displaceable axially on the shaft 4 counter to the force of a cup spring assembly 16. The cup spring assembly 16 is located between the driven gear wheel 14 and the adjacent face end 8 of the shaft 4 and is braced against an axially nondisplaceable abutment 18 that adjoins the face end 8 and is supported freely rotatably on the shaft 4.

The shiftable clutch 2, located between the two driving gear wheels 10, 12 on one side and the driven gear wheel 14 on the other, includes a first, essentially annular clutch element 20, which is integrally formed onto the face end, adjacent to the driven gear wheel 14, of the larger driving gear wheel 12 and is thus joined to the latter in a manner fixed against relative rotation; a second, essentially annular clutch element 22, which is integrally formed onto the face end, adjacent to the larger driving gear wheel 12, of the driven gear wheel 14 and is thus joined to the latter in a manner fixed against relative rotation and is freely rotatable relative to the shaft 4; and a third, essentially annular clutch element 24, which is freely rotatable between the two clutch elements 20, 22 and which, like the driven gear wheel 14 and the clutch element 24, is supported axially displaceably on the shaft 4 counter to the force of the cup spring assembly 16.

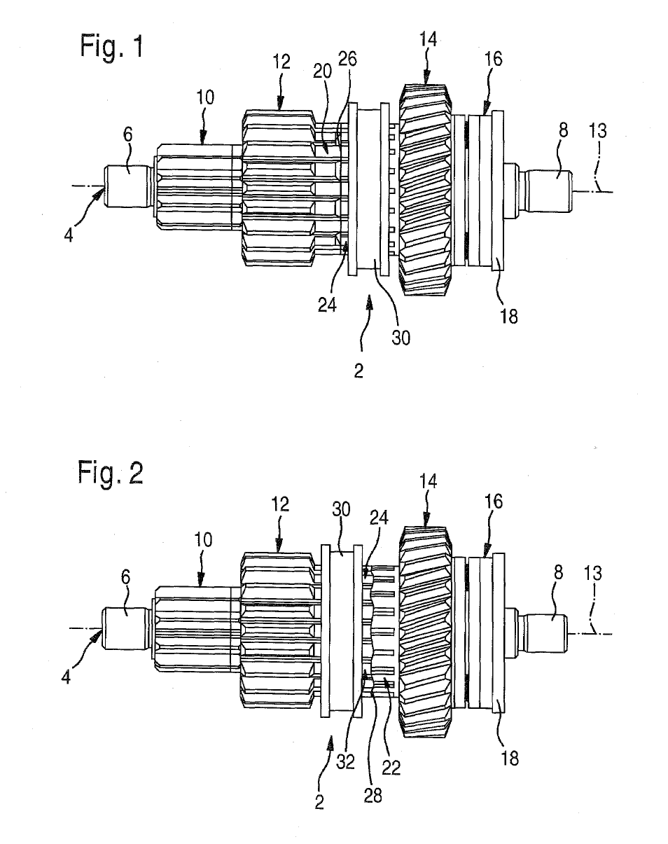

The adjacent first and third clutch elements 20, 24 have end faces 26, diametrically opposite one another and serving as clutch faces, which are provided with complementary ratchet contours, as best seen in FIG. 1, while the diametrically opposed end faces 28, also acting as clutch faces, of the adjacent second and third clutch elements 22, 24 are provided with complementary undulating contours, as best seen in FIG. 2. Because of the different profiling of the two pairs of clutch faces 26 and 28, these pairs have different disengagement torques at which the diametrically opposed clutch faces 26 and 28, respectively, begin to rotate counter to one another, for instance when the drill spindle with the drilling tool, and thus the driven gear wheel 14, are blocked. While the undulating profile has a lesser depth and/or gently rounded troughs and crests, the ratchet profile has a greater profile depth and/or steeper flanks, so that the maximum transmissible torque, corresponding to the applicable disengagement torque, between the clutch faces 26 and 28 is greater with the ratchet profile than with the undulating profile.

The clutch 2 further includes a switching ring 30, which can be displaced between the driving gearwheel 12 and the driven gearwheel 14 in the axial direction along the outer circumferential faces of the three clutch elements 20, 22, 24 by the actuation of a switch on the outside of the housing of the power percussion drill. The circumferential faces have the same diameter and are provided with axial keyways or splines 32 corresponding to one another, which are engaged at corresponding angular spacings in form-locking fashion via keys (not visible) that protrude past an inner circumferential face of the switching ring. The width of the switching ring 30 is adapted to the axial length of the three clutch elements 20, 22, 24 in such a way that, in a first clutch state, shown in FIGS. 1 and 4, it spans the two diametrically opposed clutch faces 28 of the second and third clutch elements 22, 24 and connects the latter to one another in a manner fixed against relative rotation, while the diametrically opposed clutch faces 26 of the first and third clutch elements 20, 24 remain free, so that if a first disengagement torque, predetermined by the ratchet profile and the contact pressure of the cup spring assembly 16, is exceeded, they can rotate relative to one another.

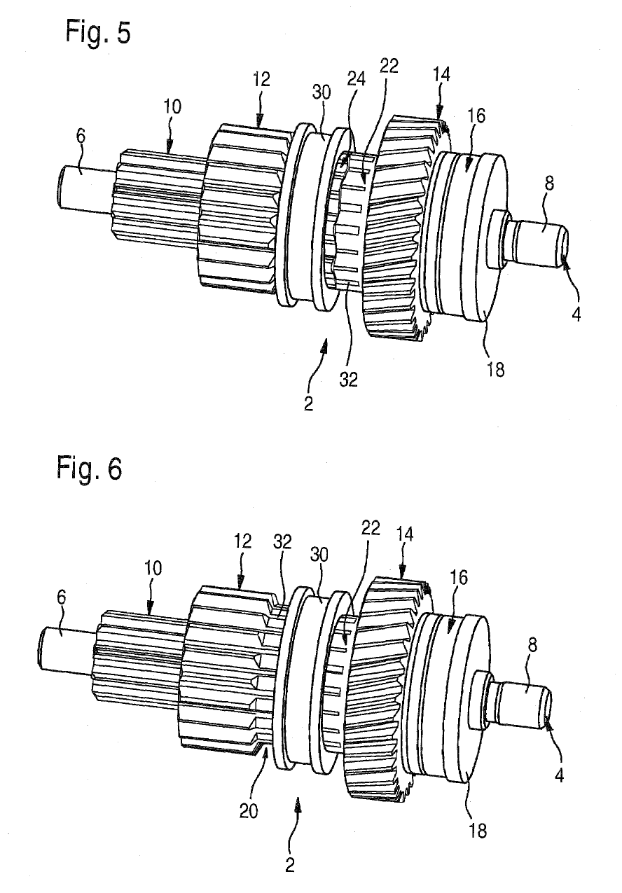

In a second clutch state, shown in FIGS. 2 and 5, the switching ring 30 conversely spans the two diametrically opposed clutch faces 26 of the first and third clutch elements 20, 24, causing them to be connected to one another in a manner fixed against relative rotation, while the diametrically opposed clutch faces 28 of the second and third clutch elements 22, 24 remain free, so that they can rotate counter to one another if a second disengagement torque, predetermined by the shaft profile and the contact pressure of the cup spring assembly 16, is exceeded.

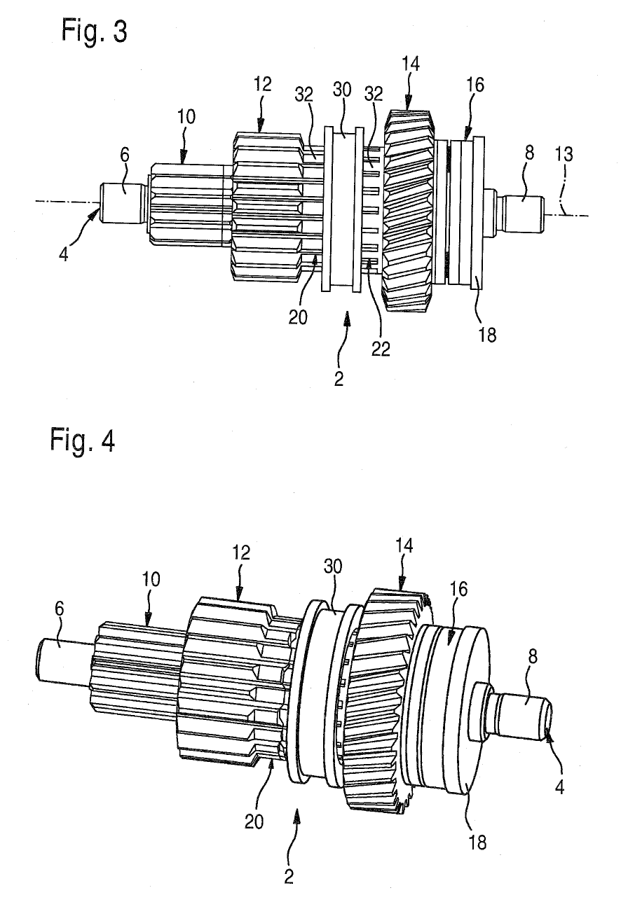

In a third clutch state, shown in FIGS. 3 and 6, the switching ring 30 spans both pairs of diametrically opposed clutch faces 26 and 28, and as a result, the clutch 2 is blocked because of the form lock between the switching ring 30 and the two clutch elements 20 and 22 and the resultant connection, in a manner fixed against relative rotation, between the driven gear wheel 14 and the driving gear wheels 10, 12, or the shaft 4.

In a power percussion drill having the above-described clutch 2, it is thus possible, by a suitable displacement of the switching ring 30, to select different maximum torques at the drill spindle or drilling tool, which can be adapted to one another in a finely graduated manner because of the additional possibility of a suitable choice of gear speeds. Thus by the combination of the three possibilities for selecting the clutch state and the two possibilities for selecting the gear speed, a total of six different torques can be selected, such as, in the clutch state of FIGS. 2 and 5 with maximum safety to the user, a torque of approximately 20 Nm in first gear and a torque of approximately 12.5 Nm in second gear; in the clutch state of FIGS. 1 and 4, with normal safety to the user, a torque of approximately 70 Nm in first gear and a torque of approximately 30 Nm in second gear; and in the clutch state of FIGS. 3 and 6, without any protection whatever for the user, the maximum blocking torque as applicable in both first and second gear, the figures given being dependent on the maximum torque of the drive motor and on the applicable gear ratio of the transmission.

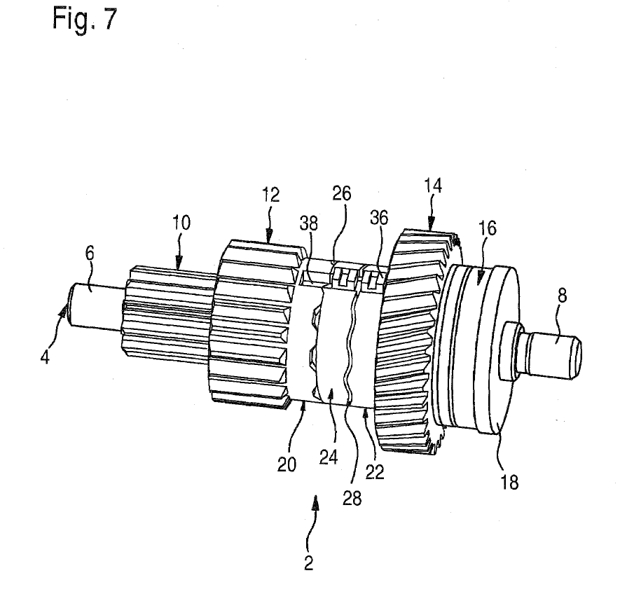

The clutch 2 shown in FIG. 7 differs from the clutch 2 described above in that instead of the switching element 30, a draw key 36 is shown, which can be displaced from the outside of the housing of the power percussion drill in an axial spline 38 of the three clutch elements 20, 22, 24. The length of the draw key 36 corresponds to the width of the switching ring 30, so that once again, the three clutch states shown in FIGS. 1 and 4, FIGS. 2 and 5, and FIGS. 3 and 6 can also be set.

1. A clutch for a hand-actuated electric power tool, in particular for a handheld electric tool, such as a power drill or power percussion drill, having a rotating tool, in which the clutch disengages automatically if a defined disengagement torque is exceeded, characterized in that the clutch (2) is capable of being switched over between two clutch states, in which the disengagement torque is variously high.

2. The clutch as defined by claim 1, characterized in that it is capable of being switched over to a further clutch state, in which it is blocked.

3. The clutch as defined by claim 1, characterized in that it includes two pairs of clutch faces (26 and 28, respectively), which automatically rotate counter to one another at variously high disengagement torques, and in each of the two clutch states, one of each of the two pairs of clutch faces (26 and 28, respectively), is blocked against rotation.

4. The clutch as defined by claim 3, characterized in that the clutch faces (26 and 28, respectively) in each pair have different engagement contours and/or surface properties.

5. The clutch as defined by claim 3, characterized in that the clutch faces (26 and 28, respectively) of each pair are pressed against one another with essentially the same force by a single contact pressure device (16).

6. The clutch as defined by claim 3, characterized in that the two pairs of clutch faces (26 and 28, respectively) are each formed by diametrically opposed axial end faces of three clutch elements (20, 24, 22) located in line with one another along an axis of rotation (13).

7. The clutch as defined by claim 6, characterized in that two of the three clutch elements (22, 24) are supported rotatably on a shaft (4); and that a third clutch element (20) is connected to the shaft (4) in a manner fixed against relative rotation.

8. The clutch as defined by claim 6, characterized in that two each (20, 22; 22, 24) of the three clutch elements (20, 24, 22) are connected to one another in a manner fixed against relative rotation by means of a switching element (30) that is movable in the direction of the axis of rotation (13) of the clutch elements (20, 22, 24).

9. The clutch as defined by claim 8, characterized in that in two terminal positions of the switching element (30), one of each of the two pairs of clutch faces (26 and 28, respectively) is blocked against rotation; and that in a middle position of the switching element (30), both pairs of clutch faces (26 and 28) are blocked against rotation.

10. An electric power tool, in particular a hand-actuated electric machine, having a rotating tool, characterized by a clutch as defined by claim 1.
